(19) United States
(12) Patent Application Publication
(10) Pub. No.: US 2004/0190048 A1
(43) Pub. Date: Sep. 30, 2004

(54) Image forming device and method

(75) Inventors: Satoshi Egawa, Iwatsuki-shi (JP); Hideaki Sugimoto, Iwatsuki-shi (JP); Hideaki Takayama, Iwatsuki-shi (JP); Kazunobu Uchiyama, Iwatsuki-shi (JP); Hiroyuki Watanabe, Iwatsuki-shi (JP)

Correspondence Address: OLIFF & BERRIDGE, PLC, P.O. BOX 19928, ALEXANDRIA, VA, 22320, US

(73) Assignee: FUJI XEROX CO., LTD., Minato-ku (JP)

(21) Appl. No.: 10/725,419

(22) Filed: Dec. 3, 2003

(30) Foreign Application Priority Data
Mar. 24, 2003 (JP) 2003-080999

(51) Int. Cl. G06F 15/00; G06F 3/12; G06F 13/00

(52) U.S. Cl. 358/1.15; 358/1.16

(57) ABSTRACT

An image forming device and method enable editing of printing data while a printing sequence of the printing data transmitted to an image forming device is maintained. The printing data transmitted to the image forming device from an information processor is stored in a memory of the image forming device. For the editing of the printing data, the printing data stored in the memory of the image forming device is edited and is then provided as the printed output using the information processor without deletion of the printing data stored in the image forming device.

### BACKGROUND OF THE INVENTION

1. Field of Invention

The present invention relates to an image forming device and method, and particularly to an image forming device and method which can perform editing of printing data that has been transmitted to the image forming device.

2. Description of Related Art

Writing of sentences and editing of images or the like using an information processor such as a PC (personal computer) are performed in various aspects of daily life, and these sentences are output for printing by transmission to an image forming device, such as, for example, a printer, as printing data.

The image forming device outputs, upon reception of the printing data, the data received for printing after execution of any necessary processes. The image forming device also processes respective printing data in the sequence of its reception when plural printing data items are received.

However, in the case where it is desired to correct errors of sentences by editing printing data that already has been transmitted to the image forming device, the printing data already transmitted to the image forming device must be deleted, and the printing data which has been edited has to be transmitted to the image forming device.

Therefore, if another user has transmitted the printing data to the image forming device before transmission of the edited printing data, the printing order having the edited printing data is placed last in the printing queue, causing the user who sent the edited printing data to wait until the edited printing data is printed from the queue.

### SUMMARY OF THE INVENTION

Accordingly, the present invention is intended to provide an image forming device and method which enable editing of printing data while a printing order of the printing data transmitted to an image forming device is maintained.

An image forming device according to one aspect of the present invention is provided with a memory that stores printing data, an editing part that enables editing of the printing data stored in the memory of the image forming device, a data processing part that performs data processing for providing image data from the printing data stored in the memory, and a printing mechanism that provides printed output of the image data output by the data processing part.

In addition, the data processing part may start the data processing after an editing-allowable state of the printing data has been completed.

The data processing part may start processing of subsequent printing data when the printing data that is to be processed is in the editing-allowable state.

The processing of the printing data in the editing-allowable state is started when the processing of the subsequent printing data is completed.

Preferably, the printing data remains stored in the memory after the printed output is provided.

In addition, a transmitting part is also provided to transmit the printing data stored in the memory to the information processor.

The data processing part may start the data processing after the printing data is received completely.

The editing part may only enable editing of printing data which satisfies a predetermined condition.

In addition, the editing part may enable editing of printing data when it determines that the information processor which transmitted the printing data is identical to the information processor which requested the editing of the printing data.

The editing part may enable editing of the printing data when user information added to the printing data is identical to user information input by a user who requests editing.

According to another aspect of the invention, an image forming method stores, in an image forming device, printing data transmitted from an information processor, allows editing of the printing data stored in the image forming device by the information processor, and provides printed output of the edited printing data after the editing is completed.

Subsequent printing data to the printing data being edited may be output as the printed output when the editing of the printing data is not yet completed.

The printing data whose editing has been completed is output when processing of the printing data being output as the printing output is completed.

The printing data can be stored in the image forming device after the printing data is output as the printing output.

The stored printing data can be transmitted to the information processor from the image forming device.

The editing of the printing data can be allowed when the printing data satisfies a predetermined condition.

The editing of the printing data can be allowed when the information processor which has transmitted the printing data is identical to the information processor which requests the editing.

### BRIEF DESCRIPTION OF THE DRAWINGS

Preferred exemplary embodiments of the present invention will be described in detail based on the following drawings, in which:

FIG. 1 is a schematic block diagram showing an exemplary structure of an image forming device of an embodiment of the present invention;

FIG. 2 is a flowchart showing exemplary operations of the image forming device of an embodiment of the present invention;

FIG. 3 is a status transition diagram showing an example of the status transition of data processes in an image forming device of an embodiment of the present invention;

FIG. 4 is a flowchart showing operations of the image forming device which has received an editing request of the printing data;

FIG. 5 is a flowchart showing operations of the image forming device which includes the printing data in the printing order;

FIG. 6 is a flowchart showing operations of the image forming device which provides previously the printing output of the printing data in the printing order by skipping the order of the printing data being edited;

FIG. 7 is a flowchart showing operations of the image forming device which allows interruption of the printing data after completing the editing;

FIG. 8 is a flowchart showing operations of the image forming device which allows transmission of the printing data to an information processor from the image forming device;

FIG. 9 is a flowchart showing operations of the image forming device which allows editing only of the printing data which satisfies a predetermined condition; and

FIG. 10 is a flowchart showing operations of the image forming device which allows editing only when a user who has transmitted the printing data requests editing of the printing data.

### DETAILED DESCRIPTION OF PREFERRED EMBODIMENTS

One preferred exemplary embodiment of an image forming device operating according to principles of the present invention will be described in detail with reference to the accompanying drawings.

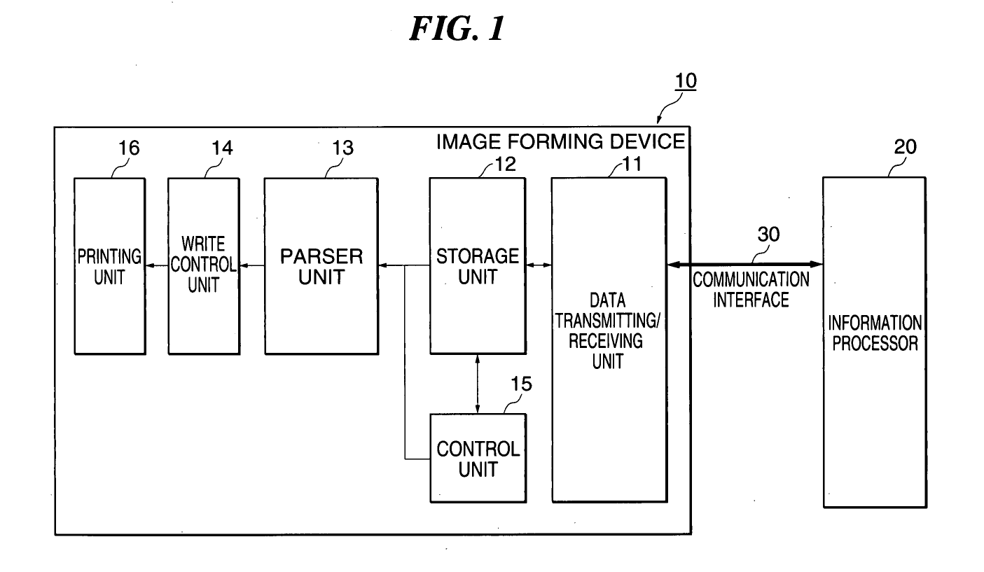

FIG. 1 is a schematic diagram showing an example of structure of an image forming device of an embodiment of the present invention. The image forming device 10 is provided with a transmitting/receiving unit 11 to transmit and receive the printing data to/from an information processor 20 such as PC, and a communication interface 30. The image forming device 10 also includes a storage unit 12 (memory) to store the printing data, a Parser unit 13 to interpret the printing data expressed in PDL (Page Description Language), a write processing unit 14 to develop the printing data interpreted by the Parser unit 13 into image data, a control unit (controller) 15 to control the image forming device 10, and a printing mechanism 16 to print the image data to a printing sheet.

Here, the transmitting/receiving unit 11 transmits and receives the printing data and also receives an instruction from the information processor 20 such as an editing request of the printing data. The printing mechanism 16 can print images by various printing techniques, for example, by laser printing, ink-jet printing (thermal or piezoelectric, for example), thermal printing, impact printing, etc. The printing can be in color or black-and- white. The image forming device 10 can be a printer, a facsimile machine, a combination printer/facsimile machine, a photo-copier, etc.

The Parser unit 13 can interpret a file generated by an application of the information processor, in addition to performing the PDL interpretation, to process the printing data expressed with ordinary page description language. Accordingly, the Parser unit 13 can process the printing data to enable the printing with the printing mechanism by interpreting the printing data corresponding to the application being used by the information processor.

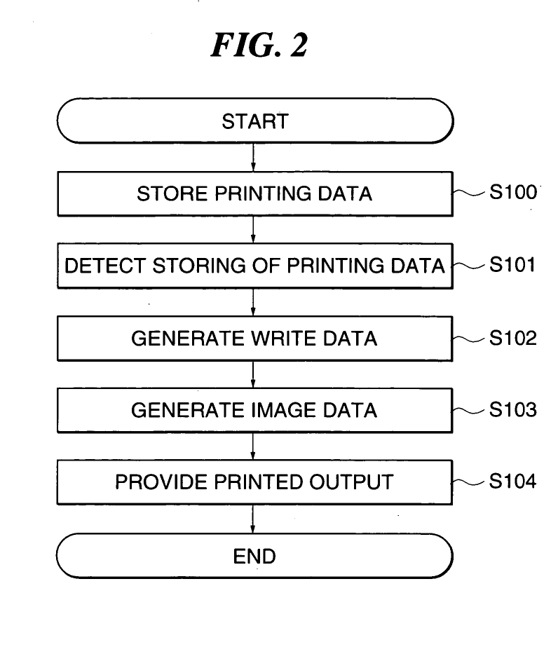

In the structure described above, when the transmitting/receiving unit 11 receives the printing data transmitted from the information processor 20, the image forming device 10 of the present invention stores, as illustrated in FIG. 2, the received printing data by accumulating it in the storage unit 12 (step S100).

Next, when the printing control unit 15 detects start of accumulation of the printing data (step S100), it instructs the Parser unit 13 to start processing the printing data. The Parser unit 13 generates write data to be processed by the write processing unit 14 from the printing data stored in the storage unit 12 (step S102).

The write processing unit 14 converts the write data to image data to be printed by the printing mechanism 16 (step S103) and the printing mechanism 16 provides the image data as the printed output (step S104).

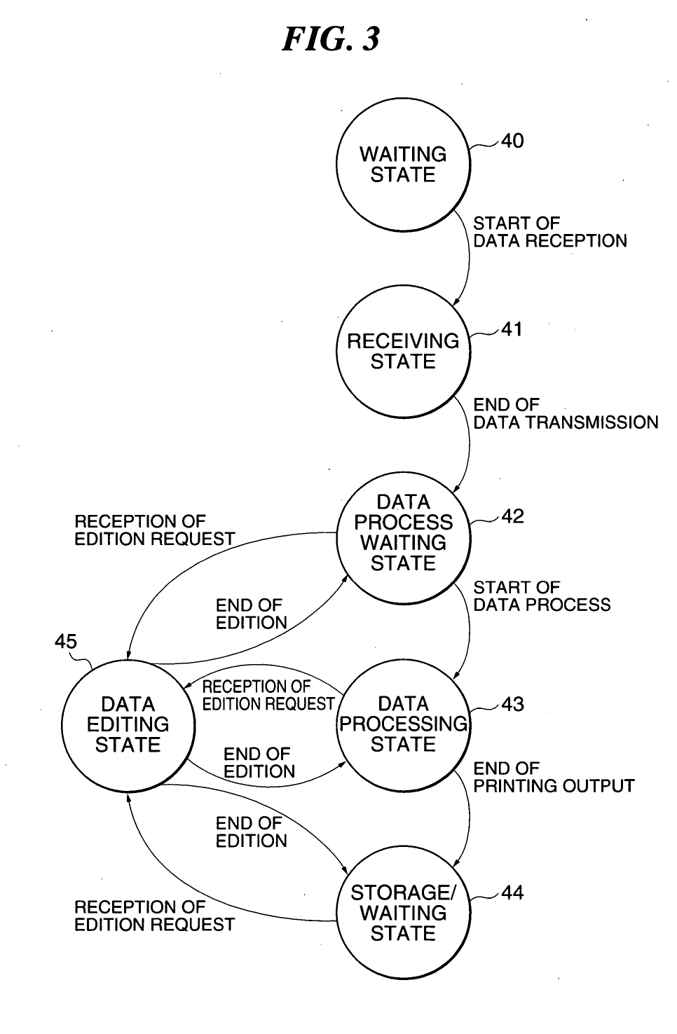

An example of the states of the image forming device through which the image forming device transitions depending on the process of the image data according to one aspect of the present invention will be described with reference to FIG. 3.

First, when the printing data is received under the state 40 waiting for reception of the printing data, the image forming device shifts to the receiving state 41 and then shifts to the processing waiting state 42 when all the printing data has been received.

When the processing of the printing data starts, the operating state of the image forming device shifts to the processing state 43 and then shifts back to the storage/waiting state 44 upon completion of the printing process.

When the image forming device receives an editing request from the information processor 20 when the image forming device 10 is in the processing waiting state 42, the processing state 43 or the storage/waiting state 44, the image forming device 10 shifts to the editing state 45 to allow the editing of the printing data. When the editing of the printing data is completed, the image forming device shifts to the state that it was in before it transitioned to the editing state 45.

In the present embodiment of the invention, as described above, after the printing data is transmitted to the image forming device from the information processor, editing of the printing data stored in the image forming device is allowed in accordance with the editing request of the information processor. When the editing is completed, the processing that was being executed is implemented again using the printing data of which the editing has been completed.

The printing data can be edited, for example, with a method in which access is provided to the printing data stored in the storage unit of the image forming device by the information processor, and that printing data is edited using the information processor. The editing can be done in the image forming device or in the information processor. According to one example, the printing data that is to be edited is sent back to the information processor from the image forming device for editing by the information processor. According to another example, the printing data that was previously sent to the image forming device is replaced with edited printing data that was edited in the information processor.

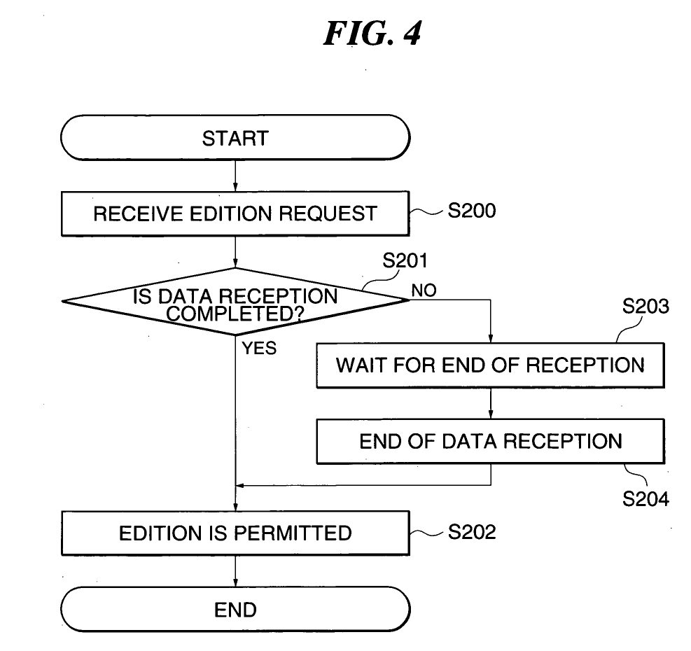

Next, with reference to FIG. 4, operations of the image forming device which has received the editing request of the printing data from the information processor will be described.

First, when an editing request of the printing data is received (step S200), it is determined whether or not receipt of the printing data is completed (step S201). When receipt of the printing data is completed (YES in the step S201), the editing of the printing data is allowed (step S202).

On the other hand, when receipt of the printing data is not yet completed (NO in step S201), reception of the printing data is continued until reception is completed (step S203). When reception of the printing data is completed (step S204), editing of the printing data is allowed (step S202).

In this embodiment, when an editing request of the printing data is issued before the completion of reception of the printing data, the editing of the printing data is allowed after the completion (the end) of reception of the printing data. However, when editing of the printing data is possible while the printing data is being received, it also is possible to permit the editing of the received printing data as further printing data is being received. Moreover, it also is possible to cancel the editing request without permitting the editing.

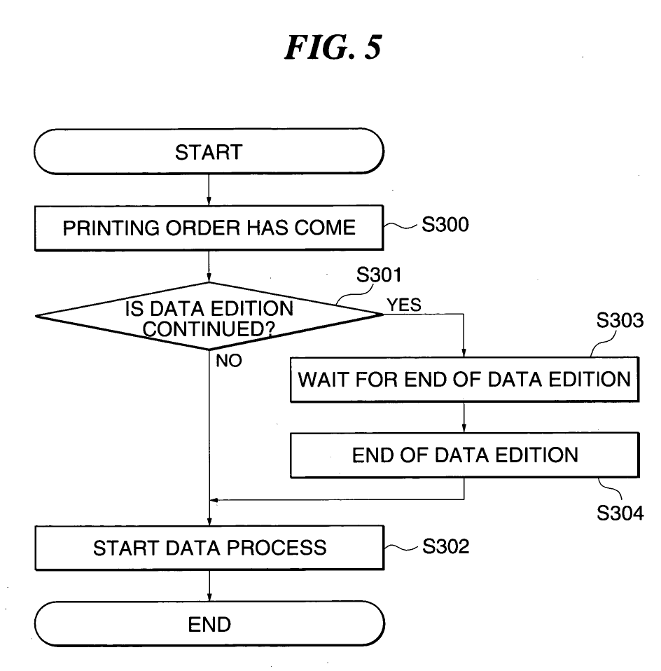

The image forming device usually provides the printed output through implementation of its various processes depending on the receiving order of the printing data as it receives plural printing data items (for example, plural pages or plural jobs). Operations of the image forming device while it is in the processing waiting state 42 will be described with reference to FIG. 5.

First, when printing data that was in the waiting state falls to the printing order (step S300) (that is, when the printing mechanism 16 is now available to print a page or job, etc., that has been received by the image forming device and has been waiting to be printed), it is determined whether or not the relevant printing data is being edited (step S301). When the printing data is not being edited (NO in step S301) (either because the editing has been completed, or no editing was requested), the process of the printing data is started (step S302).

When printing data is being edited (YES in step S301), the editing of the printing data is continued until it is completed (step S303). When the editing of the printing data is completed (step S304), the processing of the printing data having completed editing is started in the predetermined timing at the end of editing of the printing data (step S302).

Whether or not the printing data is being edited can be determined depending on whether or not the editing is allowed to the printing data.

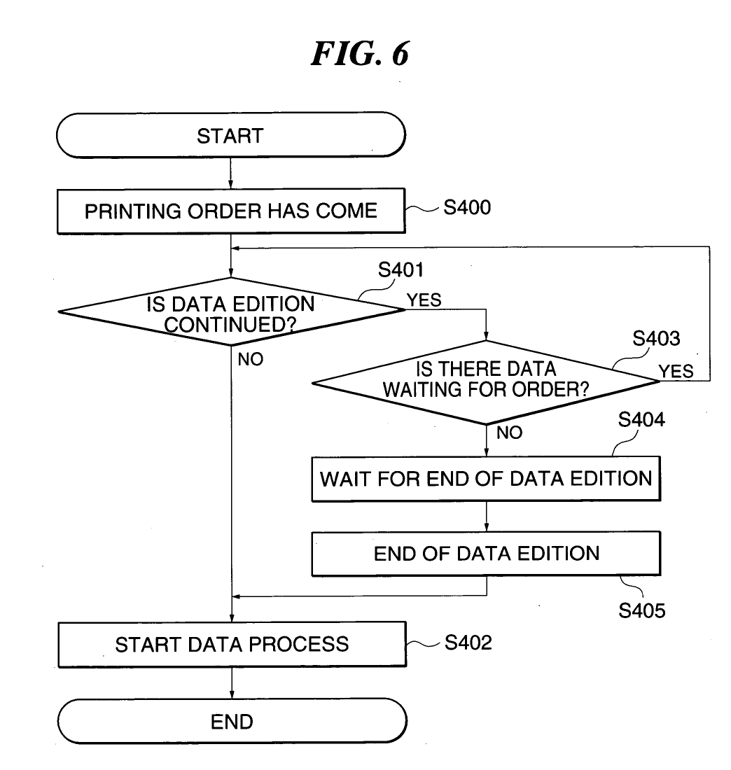

When the printing data being edited falls on the order of the printing process (i.e., its turn to be printed arrives), it also is possible to print the printing data that is next in the assigned order while editing of the printing data is completed (assuming that the next printing data is not scheduled for editing). Operation of the image forming device to output the printing data that was in the waiting state by skipping the order of the printing data being edited (i.e., by skipping over printing data being edited) will be described with reference to FIG. 6.

First, when the printing order for a particular printing data (called first printing data herein) has come (step S400), whether or not that first printing data is being edited is determined (step S401). When the printing data is not edited (NO in step S401), the processing of the printing data is started (step S402).

When the first printing data is being edited (YES in step S401), it is determined whether or not there is printing data (next or second printing data) waiting for the order of the printing output (step S403). When it is determined that there is (next or second) printing data waiting for the printing output (YES in step S403), it is determined whether or not printing data is to be edited (step S401).

When it is determined that there is no (next or second) printing data waiting for the printing order (NO in step S403), the editing of the first printing data is continued until it is completed (step S404). When the editing of the (first) printing data is completed (step S405), the processing of the (first) printing data is started in the predetermined timing when the editing of the printing data is completed (step S402).

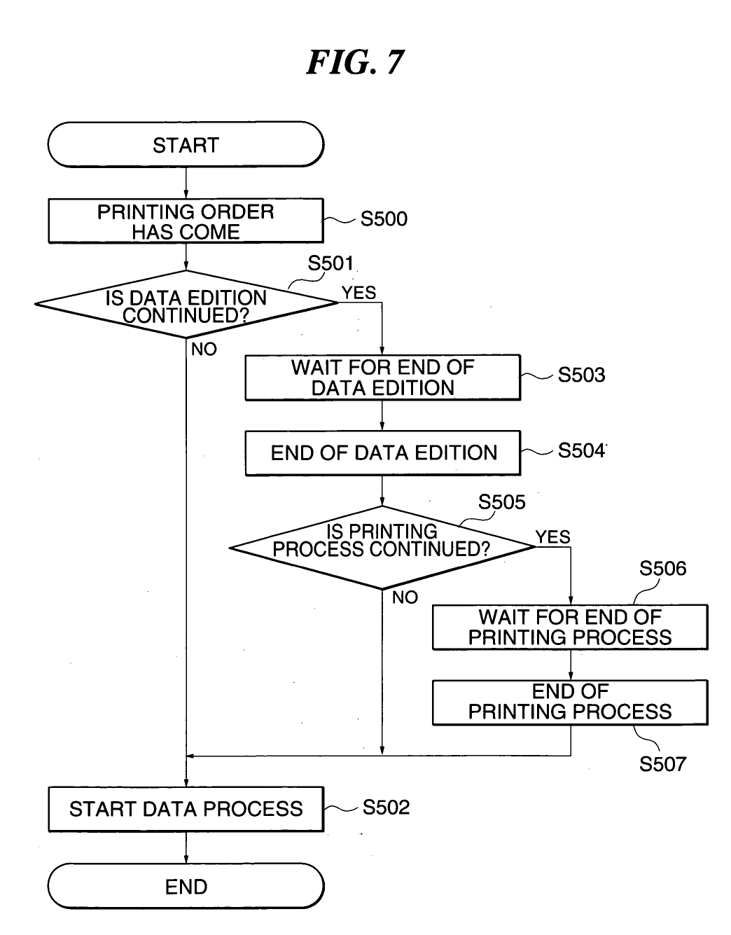

When other (second or next) printing data has been printed by skipping the order of the (first) printing data being edited, it also is possible to print out, in the timing of discontinuous jobs, the (first) printing data whose printing order has been skipped by interruption (or re-insertion into the queue) of the printing among the printing data that is waiting for the printing operation. Therefore, operation of the image forming device to interrupt printing when the previously skipped printing data has completed being edited will be described with reference to FIG. 7.

First, when the printing order of some particular printing data (called printing data A) has come (step S500), it is determined whether or not the printing data A is to be edited (step S501). When the printing data does not need to be edited (NO in step S501), the process of the printing data is started (step S502).

When it is determined that the printing data is being edited (YES in step S501), the printing data A continues being edited until the end of editing (step S503). When the editing of the printing data is completed (step S504), it is determined whether or not there is printing data (printing data B) under printing processing (step S505).

When it is determined that there is no printing data undergoing printing processing (NO in step S505), the processing of the printing data A which has been edited is started (step S502).

When it is determined that there is printing data (B) undergoing printing processing (YES in step S505), the printing processing of the printing data (B) is continued until it is completed (step S506). When the printing processing of printing data B is completed (step S507), the processing of the printing data A whose editing has been completed is started (step S502).

The printing data that is printed (output) often is deleted from a viewpoint of the capacity of the storage unit, but it also is required frequently to perform the editing of the printing data by verifying a printed matter as the printed output. Therefore, it is preferable to store the printing data as the printed output into the printing data storage unit.

If the printing data as the printed output is lost on the side of (i.e., lost by) the information processor, the printing data also can be transmitted to the information processor from the image forming device by storing the printing data in the image forming device.

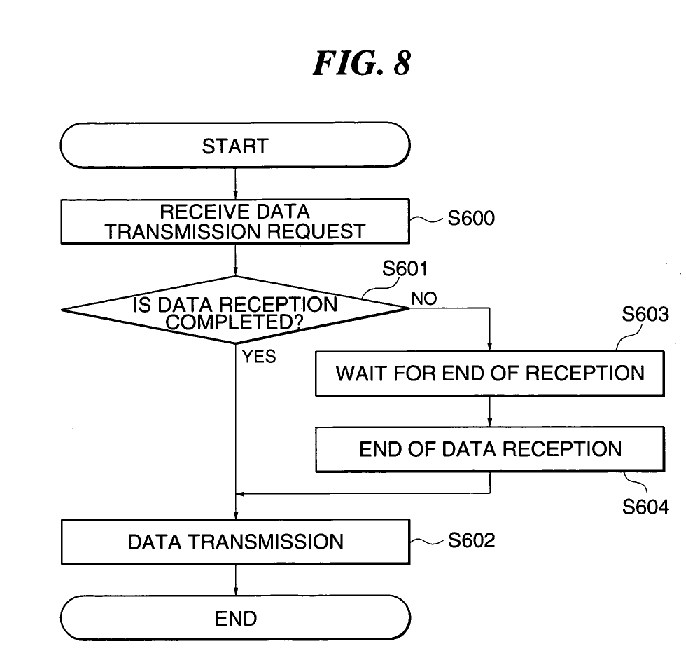

Operation of the image forming device to transmit the printing data to the information processor from the image forming device will be described with reference to FIG. 8.

First, when a transmission request of the printing data is received (step S600), it is determined whether or not reception of the printing data is completed (step S601). When the reception of the printing data is completed (YES in step S601), the printing data is transmitted to the information processor (step S602).

In addition, when the reception of the printing data is not yet completed (NO in step S601), the reception of the printing data is continued until the reception is completed (step S603). When the reception of the printing data is completed (step S604), the printing data is transmitted to the information processor (step S602).

In this embodiment, when the reception of the printing data is not yet completed, the printing data is transmitted to the information processor after the end of reception of the printing data, but it also is possible to cancel the transmission request of the printing data without transmitting of the printing data.

When the editing is allowed for all printing data received by the image forming device, there rises a fear that a burden on the image forming device becomes heavier.

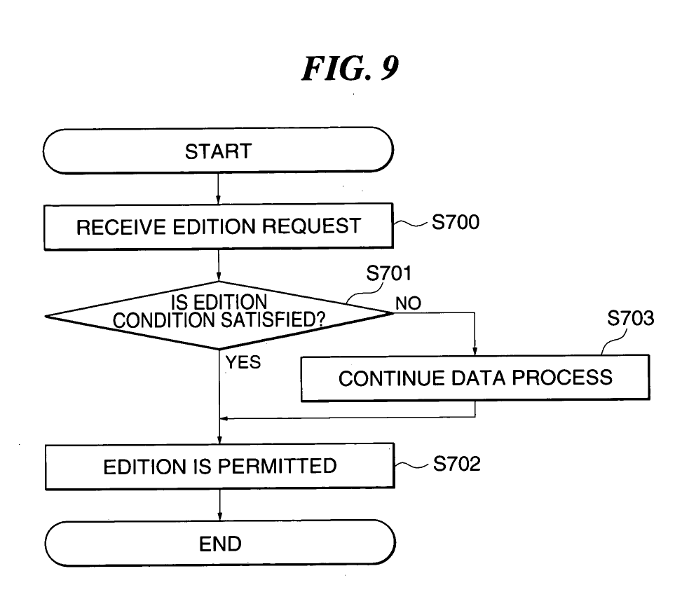

Therefore, operation of the image forming device which allows the editing to be performed only to printing data which satisfies a predetermined condition will be described with reference to FIG. 9.

First, when an editing request of the printing data is received (step S700), it is determined whether or not the printing data satisfies the editing condition (step S701). When the editing condition is satisfied (YES in step S701), the state shifts to the printing data editing state (step S702).

If the editing condition is not satisfied (NO in step S701), the process of the printing data is continued (step S703).

When the printing data does not satisfy the editing condition, a message informing that editing of the printing data is not allowed is notified to the information processor.

The predetermined, acceptable editing conditions may include, for example, “there are more than a predetermined number of jobs (i.e., processing of other printing data) to be executed until the start of the printing processing of the relevant printing data (that is desired to be edited)”, “it is assumed that more than a predetermined amount of time is required before the start of the printing processing of the relevant data” and “it is assumed that more than a specified number of sheets are to be printed before the start of the printing processing of the relevant data.” It also is possible that the editing of the printing data is allowed when any one of these conditions or at least a predetermined number of these conditions are satisfied.

The image forming device is often connected with plural information processors via a network such as LAN (Local Area Network). In this case, it is preferable that the editing of printing data is allowed only to the user who has transmitted the printing data.

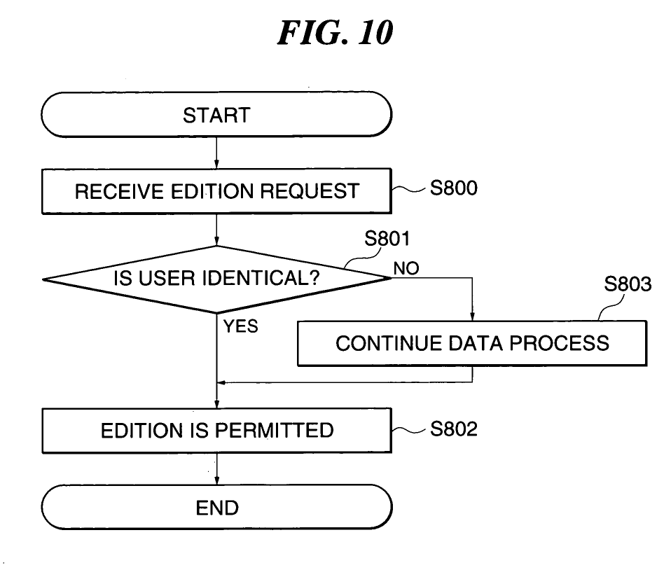

Accordingly, operation of the image forming device which allows the editing of printing data only when the user who transmitted the printing data has issued an editing request of the printing data will be described with reference to FIG. 10.

First, when an editing request of the printing data is received (step S800), it is determined whether or not a user at the transmission source of the editing request is identical to a user at the transmission source of the printing data which is the object of editing (step S801). When the users are identical (YES in step S801), the state shifts to the printing data editing state (step S802).

When the users are not identical (NO in step S801), the printing data processing is continued (step S803).

A user may be verified by comparing the IP addresses of the printing data transmission source and the edition request transmission source. Moreover, the user can also be verified by instructing the transmitting party of the printing data and of the editing request to transmit the information for identifying the user in addition to the data to be transmitted to the image forming device and then comparing the user information.

When a user who has transmitted the printing data is different from a user who has transmitted the editing request, it is possible to send a message that editing of the printing data is not allowed to the user who has transmitted the editing request. In this case, it is possible to send a message that the editing requests have been issued from a user who is different from the user who has transmitted the printing data.

In the present invention, it is possible, as described above, that the printing data transmitted to the image forming device from the information processor such as PC is stored in the storage unit (memory) of the image forming device and the printing data stored in the storage unit is edited by users.

Accordingly, the printing data transmitted can be corrected without deletion of the printing data transmitted to the image forming device. Namely, according to one embodiment of the invention, the printing data can be corrected in the state that the printing sequence of the printing data is maintained. The printing order is lost in the conventional printing data correcting method in which the printing data transmitted to the image forming device is deleted and the edited printing data needs to be transmitted to the image forming device and then places last in order.

Moreover, the image forming device is capable of preventing unwanted data processing and printing output because the printing data being (or to be) edited is not printing processed, and only the edited printing data after completion of the editing is printing processed.

In addition, printing output can be implemented very effectively by printing the printing data of a subsequent printing order (i.e., when earlier printing data in the order is being edited).

Furthermore, since the data stored in the image forming device is edited, it is no longer required to transmit all printing data of which the editing has been completed to an image forming device from an information processor and it also is possible to perform the editing only with transmission and reception of the necessary data.

As described above, according to some embodiments of the invention, the printing data can be edited with the printing sequence being maintained.

The controller (e.g., the control unit 15) of the illustrated exemplary embodiments is implemented as one or more programmed general purpose computers. It will be appreciated by those skilled in the art that the controller can be implemented using a single special purpose integrated circuit (e.g., ASIC) having a main or central processor section for overall, system-level control, and separate sections dedicated to performing various different specific computations, functions and other processes under control of the central processor section. The controller can be a plurality of separate dedicated or programmable integrated or other electronic circuits or devices (e.g., hardwired electronic or logic circuits such as discrete element circuits, or programmable logic devices such as PLDs, PLAs, PALs or the like). The controller can be implemented using a suitably programmed general purpose computer, e.g., a microprocessor, microcontroller or other processor device (CPU or MPU), either alone or in conjunction with one or more peripheral (e.g., integrated circuit) data and signal processing devices. In general, any device or assembly of devices on which a finite state machine capable of implementing the procedures described herein can be used as the controller. A distributed processing architecture can be used for maximum data/signal processing capability and speed.

While the invention has been described with reference to preferred exemplary embodiments thereof, it is to be understood that the invention is not limited to the disclosed embodiments or constructions. On the contrary, the invention is intended to cover various modifications and equivalent arrangements. In addition, while the various elements of the disclosed invention are shown in various combinations and configurations, which are exemplary, other combinations and configurations, including more less or only a single element, are also within the spirit and scope of the invention.

What is claimed is:

1. An image forming device comprising:
a memory that stores printing data;
a controller that: (1) enables editing of the printing data previously stored in the memory of the image forming device; and performs data processing for providing image data from the printing data stored in the memory; and
a printing mechanism that provides printed output of the image data output by the controller.

2. The image forming device according to claim 1, wherein the controller starts the data processing of the printing data after an editing-allowable state of the printing data has been completed.

3. The image forming device according to claim 2, wherein the controller starts processing of subsequent printing data when the printing data next in order is in the editing-allowable state.

4. The image forming device according to claim 3, wherein the processing of the printing data in the editing-allowable state is started when the editing of the printing data is completed and the processing of the subsequent printing data is completed.

5. The image forming device according to claim 2, wherein the printing data is stored in the memory after the printed output is provided.

6. The image forming device according to claim 2, wherein the controller also transmits the printing data stored in the memory to the information processor.

7. The information forming device according to claim 1, wherein the controller starts the data processing after the printing data is entirely received by the image forming device.

8. The information forming device according to claim 2, wherein the controller starts the data processing after the printing data is entirely received by the image forming device.

9. The image forming device according to claim 1, wherein the controller enables editing of the printing data if the printing data satisfies a predetermined condition.

10. The image forming device according to claim 2, wherein the controller enables editing of the printing data if the printing data satisfies a predetermined condition.

11. The image forming device according to claim 1, wherein the controller enables editing of the printing data when an information processor which has transmitted the printing data is identical to an information processor which requests the editing of the printing data.

12. The image forming device according to claim 2, wherein the controller enables editing of the printing data when an information processor which has transmitted the printing data is identical to an information processor which requests the editing of the printing data.

13. The image forming device according to claim 1, wherein the controller enables the editing of the printing data when user information added to the printing data is identical to user information input by a user who requests editing.

14. The image forming device according to claim 2, wherein the controller enables the editing of the printing data when user information added to the printing data is identical to user information input by a user who requests editing.

15. An image forming device comprising:
storage means for storing printing data;
editing means for enabling editing of the printing data previously stored in the storage means of the image forming device;
data processing means for performing data processing to provide image data from the printing data stored in the storage means; and
printing means for providing printed output of the image data output by the data processing means.

16. The image forming device according to claim 15, wherein the data processing means starts the data processing of the printing data after an editing-allowable state of the printing data has been completed.

17. The image forming device according to claim 16, wherein the data processing means starts processing of subsequent printing data when the printing data next in order is in the editing-allowable state.

18. The image forming device according to claim 17, wherein the processing of the printing data in the editing-allowable state is started when the editing of the printing data is completed and the processing of the subsequent printing data is completed.

19. The image forming device according to claim 16, wherein the printing data is stored in the storage means after the printed output is provided.

20. The image forming device according to claim 16, further comprising transmission means for transmitting the printing data stored in the storage means to the information processor.

21. The information forming device according to claim 15, wherein the data processing means starts the data processing after the printing data is entirely received by the image forming device.

22. The information forming device according to claim 16, wherein the data processing means starts the data processing after the printing data is entirely received by the image forming device.

23. The image forming device according to claim 15, wherein the editing means enables editing of the printing data if the printing data satisfies a predetermined condition.

24. The image forming device according to claim 16, wherein the editing means enables editing of the printing data if the printing data satisfies a predetermined condition.

25. The image forming device according to claim 15, wherein the editing means enables editing of the printing data when an information processor which has transmitted the printing data is identical to an information processor which requests the editing of the printing data.

26. The image forming device according to claim 16, wherein the editing means enables editing of the printing data when an information processor which has transmitted the printing data is identical to an information processor which requests the editing of the printing data.

27. The image forming device according to claim 15, wherein the editing means enables the editing of the printing data when user information added to the printing data is identical to user information input by a user who requests editing.

28. The image forming device according to claim 16, wherein the editing means enables the editing of the printing data when user information added to the printing data is identical to user information input by a user who requests editing.

29. An image forming method comprising the steps of:
storing, in an image forming device, printing data transmitted from an information processor;
allowing editing of the printing data previously stored in the image forming device; and
providing printed output of the edited printing data by the image forming device after the editing is completed.

30. The image forming method according to claim 29, wherein subsequent printing data is output as the printed output when the editing of the printing data next in order is not completed.

31. The image forming method according to claim 30, wherein the printing data whose editing has been completed is output as the printed output when processing of the subsequent printing data is completed.

32. The image forming method according to claim 29, wherein the printing data is stored in the image forming device after the printing data is output as the printed output.

33. The image forming method according to claim 29, wherein the stored printing data is transmitted to the information processor.

34. The image forming method according to claim 29, wherein the editing of the printing data is allowed when the printing data satisfies a predetermined condition.

35. The image forming device according to claim 29, wherein the editing of the printing data is allowed when an information processor which transmitted the printing data is identical to an information processor which requests the editing.

36. A printing device comprising:
a receiving part that receives printing data from a host device;
a memory that stores the printing data received by the receiving part;
a printing controller that controls the printing data stored in the memory so as to print the printing data according to a predetermined sequence; and
an editing part that sets the printing data stored in the memory to an editing-allowable state according to a request from the host device;
wherein the printing controller temporarily stops processing of the printing data depending on an editing request for the printing data from the host device, cancels the temporary stop condition if the editing is completed when a printing order for the printing data arrives so as to perform the printing processing of the printing data after the editing of the printing data, and cancels the temporary stop condition at a predetermined timing after the end of the editing if the editing is not completed when the printing order of the printing data arrives so as to perform the printing processing of the printing data after the editing of the printing data.
